(19) United States
(12) Patent Application Publication
(10) Pub. No.: US 2008/0122219 A1
(43) Pub. Date: May 29, 2008

(54) Method and apparatus for securing printed media

(75) Inventors: Anthony Dunnigan, Berkeley, CA (US); Eleanor G. Rieffel, Palo Alto, CA (US); Laurent Denoue, Palo Alto, CA (US)

Correspondence Address: SUGHRUE MION, PLLC, 2100 Pennsylvania Avenue, N.W., Washington, DC, 20037, US

(73) Assignee: FUJI XEROX CO., LTD., Tokyo (JP)

(21) Appl. No.: 11/606,863

(22) Filed: Nov. 29, 2006

(51) Int. Cl. B42D 15/00; B42D 15/10

(52) U.S. Cl. 283/83; 283/94; 283/70

(57) ABSTRACT

A layer that assumes either opaque or transparent state depending on the applied voltage is utilized to secure printed matter. The layer may also require an electrical or optical switching signal to switch between the opaque and transparent states. The layer is provided above the document to be secured and is set to the opaque state so as to obscure the contents of the document. When a prescribed voltage is applied, the layer turns to its transparent state. However, the voltage can only be applied to the security layer in the presence of a security key. A recording system may be employed to log all key-enabled access to the document.

### BACKGROUND

1. Field of the Invention

The subject invention relates to securing and controlling access to printed media.

2. Related Art

Full compliance with various Governmental regulations, such as, HIPPA, GLB and Sarbanes-Oxley, requires the retention of many documents (including paper documents). For example, Sarbanes-Oxley sections 103 (a), 104 (d), 104(e) and 105(b) are all concerned with the storage and retrieval of documents (including paper documents). Section 105(b) goes on to state that the documents must remain confidential and secure. Section 802(a) further states that the documents should not be altered in any way.

In the art of digital documents, there are many methods to provide security and control access to digital documents. Among the generally available methods are: requiring a password, encrypting the document, etc. However, there aren't many methods available to secure printed matter, such as paper documents. Conventionally, these are simply locked in a safe, drawer, room, etc. Additionally, printed documents may be sealed in an envelope.

There are at least two drawbacks to the conventional methods of securing printed matter. First, there is no secure way to track when a document has been viewed and who has viewed it. While a logbook may be used to track viewing of the document, there is no way to ensure that every view is indeed recorded in the logbook. Second, when documents are sealed, the seal must be broken for each viewing and another seal needs to be applied.

Accordingly, there is a need in the art for improved methods of securing printed documents that preferably also enable monitoring and logging access to the documents.

### SUMMARY

The subject invention describes methods and apparatus for securing printed documents and enabling monitoring of access to the documents. Various aspects of the invention enable securing paper and ePaper documents so that they cannot be read unless the correct key is attached. Printed documents that have been secured in this manner will appear completely or partially obscured until the proper key is applied. Access can be granted to all or portions of the page depending upon the security level of the key. The key may be a small device which may also supply power to the security device and/or the ePaper when used. By adding a new layer of security to traditional documents, this invention extends their usefulness and simplifies their secure storage and transportation.

Using the aspects of the invention is much like using any encrypted electronic file, in that an authorized viewing of the file doesn't destroy the security seal. The viewed secured documents don't need to be resealed after each authorized viewing. Additionally, according to aspects of the invention, as in many digital file encryption methods, each viewing could be automatically logged into a central monitoring system.

According to various aspects of the invention, an apparatus for securing documents is provided, comprising: a layered arrangement of a security layer sandwiched between two electrode layers at least one of which being transparent, the security layer assuming either an opaque state or a transparent state according to potential applied across the electrode layers, the arrangement being permanently fastened to a printed document and obscuring printed matter of the printed document when the security layer assumes the opaque state; and a coding circuitry permitting application of potential across the electrodes only when proper code has been received by the apparatus. The apparatus may further comprise a back layer forming a sleeve with the layered arrangement to enable insertion of the printed document there-between. The layered arrangement may be physically sealed to the back layer to prevent removal of the printed document without physical tempering. The apparatus may be provided such that upon application of the proper code, the security circuitry permits application of potential across the electrodes only about predefined regions to thereby cause the security layer to assume the transparent state only about the predefined regions. The apparatus may further comprise an ePaper layer, the ePaper layer capable of recording an image projected there-upon when connected to power supply, and maintaining the image after the removal of the power supply. The ePaper may be formed integrally to the layered arrangement or affixed to the layered arrangement so as to prevent separation of the ePaper and layered arrangement without physical tempering. Alternatively, the ePaper may be adhered to the layered arrangement so as to prevent separation of the ePaper and layered arrangement without physical tempering. The apparatus may be constructed so that the coding circuitry further functions to provide one or any combination of the following: enable application of power to areas of the security layer that are pre-approved for assuming the transparent state; store document metadata of the document; and store access information. The metadata may include one or combination of: document serial number, document security level, and creation date. The access information may comprise one or combination of: access time and access key ID.

According to other aspects of the invention, a system for securing printed documents is provided, comprising: a security ePaper comprising a security film and an ePaper film, the security film assuming either an opaque state or a transparent state according to potential applied across electrodes of the security film, and a coding circuitry permitting application of the potential across the electrodes only when proper code has been entered; the ePaper film fabricated to record an image projected there-upon when connected to power supply, and maintaining the image after the removal of the power supply; and an image printer, the image printer constructed to apply voltage to the ePaper for printing an image onto the ePaper; and a code key having the proper code stored therein and constructed to apply the proper code to the security film so as to cause the security film to assume the transparent state. The system may further comprise a server having stored therein serial numbers and corresponding codes of security ePapers. The server may further store access times and access key ID's relating to each access of any of the security ePapers.

According to further aspects of the invention, a method for securing printed matter is provided, comprising: physically sealing the printed matter onto a security film, the security film assuming either an opaque state or a transparent state according to potential applied across electrodes of the security film; causing the security film to assume the opaque state so as to obscure at least part of the printed matter; and monitoring security key input to the security film and applying potential across the electrodes only when the security key matches a pre-assigned code. The method may further comprise recording access information whenever a security key has been input. The access information may comprise at least an access time and an access key.

According to yet further aspects of the invention, a thin film apparatus is provided, comprising: a flat sheet-like substrate having a window section and a frame section, the window section comprising a film arrangement of a security layer sandwiched between two electrode layers at least one of which being transparent, the security layer assuming either an opaque state or a transparent state according to potential applied across the electrode layers; contact pads applied onto the frame section; and a coding circuitry provided in the frame section and coupled to the contact pads, the coding circuitry permitting application of potential across the electrodes only when proper code has been entered via the contact pads. The apparatus may further comprise means for physically sealing a document within the sheet-like substrate so that the document can be viewed only when the security layer assumes the transparent state. The substrate may further comprise an ePaper layer, the ePaper layer capable of recording an image projected there-upon when connected to power supply, and maintaining the image after the removal of the power supply. The coding circuitry may comprise printed polymer electronic circuit.

According to further aspects of the invention, an apparatus for securing documents is provided, comprising: a layered arrangement of a security layer sandwiched between two electrode layers, at least one of which being transparent, said security layer assuming either an opaque state or a transparent state according to a combination of potential applied across the electrode layers and a switching signal, the arrangement being permanently fastened to a printed document and obscuring printed matter of the printed document when the security layer assumes the opaque state; and a coding circuitry permitting application of at least one of the potential or switching signal only when proper code has been received by the apparatus. The switching signal may be an electrical or optical signal. The optical signal may be constituted by illumination of the security layer, or by lack of illumination, i.e., placement of the layer in the dark.

Additional aspects related to the invention will be set forth in part in the description which follows, and in part will be apparent from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 is a general illustration of the mechanism for a secure paper.

FIG. 2 depicts a cut-out view of a first embodiment of the invention.

FIG. 3 depicts another embodiment of the invention.

FIG. 4 depicts another embodiment incorporating a conventional printed paper document.

FIG. 5 depicts an example of system implementation according to an embodiment of the invention.

FIG. 6 depicts a document security sleeve according to an embodiment of the invention.

### DETAILED DESCRIPTION

The subject invention utilizes conventional layering technology to enable securing conventional paper documents and ePaper documents. Preliminary, ePaper technology has been developed by the subject assignee, Fuji-Xerox of Japan. The photo-addressable ePaper technology provides a photosensitive medium that, when energized, accepts a light input to generate an image that is maintained on display after the power is removed from the media. For example, if the media is energized and one uses a laser pointer to write on the ePaper, the writing will remain displayed on the ePaper after the power is removed. Similarly, if one projects an image onto the ePaper using, e.g., an LCD projector, when the ePaper is powered, the projected image will remain displayed by the ePaper after the power is removed. There are two different types of ePaper, one that is written to by light from behind, and one that is written to from the front. For further information relating to this technology the reader is directed to: H. Arisawa, et al., “Photoaddressable Electronic Paper Using Cholesteric Liquid Crystal” IS&T NIP17-228 (2001); T. Kakinuma, et al., “Black and White Photo-addressable Electronic Paper using Encapsulated Cholesteric Liquid Crystal and Organic Photoconductor” IDW '02, p. 1345 (2002); H. Kobayashi, et al., “A novel Photoaddressable Electronic Paper Using Organic Photoconductor Utilizing Hydroxy Gallium Phtalocryanine as a Charge Generation Material” Asia Display, p. 1731 (2001); S. Yamamoto, et al., “A Novel Photoaddressable Electronic Paper Utilizing Cholesteric LC Microcapsules and Organic Photoconductor” SID '01 Digest, p. 362 (2001); Hiroshi Arisawa and Kiyoshi Shigehiro, Photo-addressable E-Paper and Toner Display, IS&T's NIP20: International Conference on Digital Printing Technologies, Salt Lake City, Utah; Oct. 31, 2004; p. 922-926; and U.S. patent application Ser. No. 11/243,603, all of which are incorporated herein by reference in their entirety.

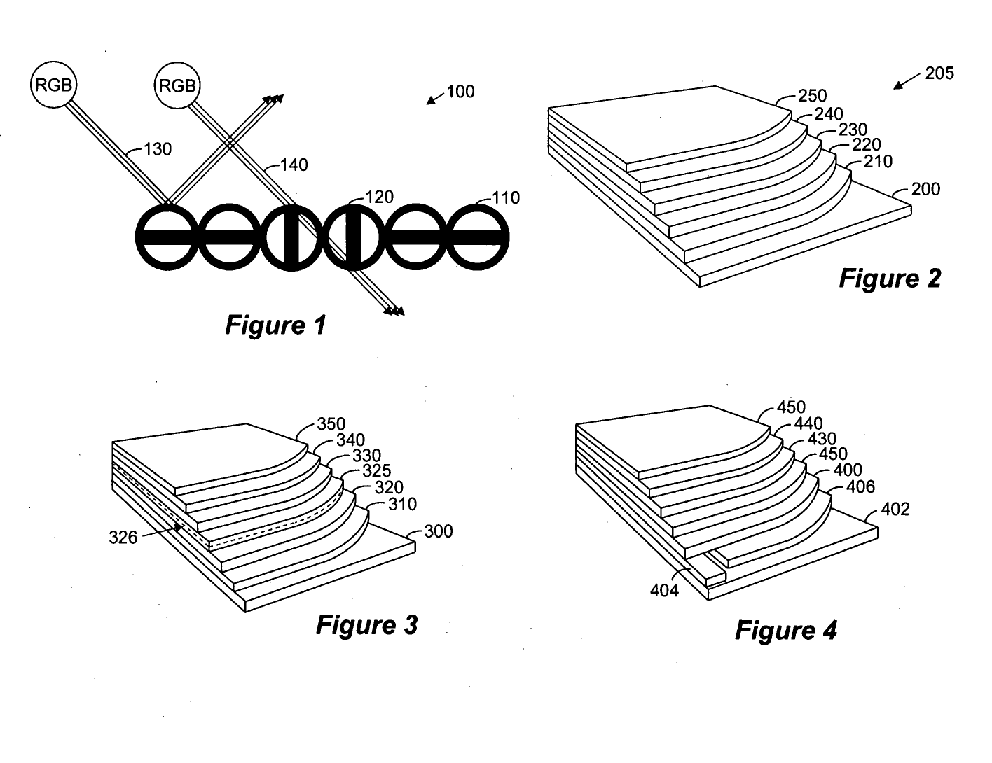

Any of the mentioned types of the ePaper may include a layer that can be switched from opaque to transparent and vice versa by applying a voltage. For example, Fuji Xerox's photoaddressable ePaper has a layer that can be made white when voltage is applied in the presence of a lot of light and will turn transparent if voltage is applied in the dark. Other types of ePaper can support this switch. For example, toner based ePaper goes from opaque to transparent when all of the toner particles are attracted to the side of each cell. Electrowetting ePaper becomes nearly transparent when the particles contract in the horizontal direction. The mechanism is illustrated in general term in FIG. 1 and further information can be found in the above-cited publications. As illustrated in FIG. 1, the layer includes particles 100 which may assume at least two states, 110 and 120. In some implementations the particles may also assume intermediate states, but for this purpose, the two states shown are of most interest. When particles 100 assume the state 110, light does not penetrate the layer, as shown by arrow 130, and the layer appears black. However, when the particles assume state 120, the layer is transparent and light can go through it, as illustrated by arrow 140.

According to embodiments of the invention, this property is advantageously used to secure printed matter. According to various embodiments, such a layer is provided above the document to be secured and is set to the opaque state so as to obscure the contents of the document. When a prescribed voltage is applied, the layer turns to its transparent state. However, the voltage can only be applied to the security layer in the presence of a security key. The security key may be provided in the form of electrical signal, optical signal, etc.

FIG. 2 depicts a cut-out view of a first embodiment of the invention. The first embodiment is implemented as a secure double-layer ePaper 205. As illustrated in FIG. 2, the double-layer ePaper comprises a base film 200, e.g., a Polyethylene Telephthalate film (generally referred to as PET film). A transparent electrode layer 210 is provided on top of the base layer 200. The transparent electrode may be, e.g., an Indium Tin Oxide layer, generally referred to as ITO electrode. While in describing various embodiments herein the term ITO would be used, it should be understood that any other electrode performing the desired function may be used instead of the ITO. Layer 220 is generally referred to herein as a document layer. The document layer 220 is the layer that functions to record and retain the image written thereupon. The constitution of the document layer 220 depends on the particular ePaper technology used. For example, document layer 220 may comprise (from bottom to top, not shown) an organic photoconductor (OPC) layer, an absorption layer, and a cholesteric liquid crystal (ChLC) layer. The OPC layer may comprise a charge transfer layer sandwiched between two charge generation layers. Security layer 230 is then provided on top of the document layer. The security layer may comprise any of the technologies described above, which enable the layer to become either opaque or transparent depending on the applied voltage. According to one embodiment, the security layer is constructed using the same layers as the document layer—hence the reference to “double-layer” ePaper. However, if the security layer 230 is constructed similar to document layer 220, the absorption layer may be omitted from the security layer 230. A second ITO electrode 240 overlays the security layer, and is capped by another base film layer 250.

The embodiment illustrated in FIG. 2 operates as follows. First, the ePaper 205 is energized to make the security layer 230 transparent and the document layer 220 receptive of an image. The image is then projected onto the ePaper 205 and the power to the document layer 220 is removed, so as to make the document layer 220 retain the image. The power to the security layer 230 is then removed, causing the security layer to assume an opaque state. In this stage, the imaged retained by the document layer 220 cannot be observed, since the security layer 230 is opaque. The security layer 230 may be made transparent only upon the application of the proper power and the appropriate security signal, for example light intensity or voltage level. However, a security circuit is provided so that power may be applied to the security layer only upon entry of the correct security code. The security code is saved onto a key (not shown), which must be connected to the ePaper in order to apply power to the security layer 230. Consequently, only persons holding the correct key may be able to view the document.

The double-layer ePaper of FIG. 2 may be implemented in several variations. According to one example, multiple writes and multiple locks are enabled as follows. Separate connectors for the document layer 220 and security layer 230 are built in to the ePaper. The document layer 220 can be written to in the same way as conventional ePaper. For example, it can be written to by placing it in an LCD printer. To “lock” the secure ePaper, voltage is applied to the security layer 230 in bright light while the key device is attached to the ePaper. If the key is not attached, the voltage will not reach the security layer so nothing will happen. With the key attached, when the voltage is applied the security layer will become opaque and the document layer 220 can no longer be seen since it is under the security layer. To “unlock” the secure ePaper 205, voltage is applied while the key is attached, but this time the surface of the ePaper must be in the dark, which can be achieved by, for example, covering the ePaper. The application of voltage and the key can be combined into a single device, e.g., a power supply key.

Another embodiment may enable a single write, multiple lock function of the secure ePaper, in which only the electrodes connecting to the security layer are accessible. The document is created by writing to normal ePaper in the usual way, and only then attaching the security layer 230 together with layers that cover the electrodes to the written ePaper 205. This type of ePaper supports read-only tamperproof documents that can only be read by a person with the correct key.

FIG. 3 depicts another embodiment of the invention. In FIG. 3, the layers are similar to that of the embodiment of FIG. 2, except that an intermediate ITO layer 325 is provided between the document layer 320 and the security layer 330. The intermediate ITO layer 325 may provide better control over power application to the document layer 320 and security layer 330. Additionally, intermediate ITO layer 325 may be constructed as two layers as illustrated by broken-line 326, thereby providing complete independent construction of the document writing and retention part and the security part. Optionally, a base layer may also be provided between the two ITO layers 325. Under such construction, the document part may be written to separately, and then the security part applied to the document part in a permanent manner, such as using adhesive. That is, initially the ePaper and the security layer are provided as two separate sheets. Once the ePaper has been written to, the security layer is permanently applied to the ePaper using, e.g., adhesive, heat seal, etc.

FIG. 4 depicts another embodiment incorporating a conventional printed-paper document. This can be conceptualized as a hybrid of ePaper and other media, such as paper. An ePaper sleeve containing a security layer is securely fastened to a conventional non-ePaper document. This sleeve could be attached permanently or in such a way that removing the paper document from the sleeve would break a security seal. The “lock” would require the same type of power supply key to make the security layer transparent. One such example is shown in FIG. 4, wherein an opaque backing sleeve material 402 is secured to the base layer 400 via means such as adhesive strip 404, heat seal, or other, so as to form a sleeve for retaining a conventional paper document 406 there between. The layers above the base 400 are ITO 410, security layer 430, ITO 440, and base layer 450. In this manner, the conventional paper document cannot be viewed unless either the arrangement is physically tempered with—which would be evident—or the proper key is attached so as to enable energizing the ITO's and make the security layer transparent.

Instead of obscuring the entire document, the security layer could contain regions which are always transparent and others that can be locked and unlocked. For example, a secure sleeve may be made in which the top of the sleeve is always transparent and may include identifying information that is not confidential. In this manner, the identity of the document can be easily deciphered without having to attach the key. As another example, standard contracts could be written on secure ePaper with only the regions with the added information lockable. Custom secure sleeve with a particular pattern of lockable and transparent zones could be manufactured as requested by customers. Furthermore, one pair of electrodes could control all the lockable regions, or multiple pairs could be provided so that one could unlock some regions while keeping others locked depending on, e.g., access permission.

Instead of obscuring preset areas, a user could select specific areas of the page to obscure. In this embodiment, an input device with the basic form factor of an eraser or a highlighting marker would be employed in addition to the power supply key. That is, the input device would be used to mark the areas of the document that the user wishes to obscure, while the key is inserted. Once the key is removed, the marked areas would be opaque until the proper key is re-inserted and the ePaper is energized.

Another embodiment enables multiple-party security. That is, according to this embodiment, more than one key is needed in order to view the document. This may be done either by having each key carry only part of the necessary code, or by using multi-layer secure sleeve. That is, by stacking security layers, one can create secure sleeve that can only be viewed if multiple parties are present. That is, each security layer may be enabled by one key; however, to view the document all of the security layers must be turned transparent. For example, a secure sleeve with three layers associated with keys belonging to three different people can only be read by any of them if they all agree to unlock their respective layer.

According to yet another embodiment, each sheet of secure paper has a unique serial number, or groups of secure papers could share a number associated with a key. During the “locking” process the key associates a code with the serial number of the secure paper, and the security layer is made opaque. The power supply key would only be able to provide the power needed to unlock the security layer of the secure paper document if it has provided the “lock” on the page with the correct code.

A central monitoring system could manage some or all power supply keys within a given system. This would prevent the loss of access to data if a key breaks. Upon encryption, the power supply key could inform the central monitoring system about which unlock code corresponds to which sheet of secure ePaper or security sleeve.

Notably, since both the power supply key and the security layer contain no information of the content being obscured, neither can be “hacked” in order to gain that information. For added protection, it is proposed that the central monitoring system would also be devoid of the content of secured documents.

Methods for defeating the “lock” might include cutting it away or bypassing it in order to power the security sleeve electrodes directly. Both methods would require piercing the page. Any obvious physical change to the document would be equivalent to breaking a security seal, making it obvious that the document was compromised. Also according to one embodiment the secure paper includes a fuse that, when it detects voltage between outer layers, it would change color to alert any later user of the document that someone tried to apply voltage directly as opposed to through the electrodes. When a legitimate user inserts the key, the fuse is bypassed by the lock and does not change color.

According to yet another embodiment, a switch is built into the secure paper that shorts out any attempt to apply voltage directly to the ITO layers. Alternatively an IC is specifically programmed to, when voltage is detected, check for the presence of the key and short out the connection if the key is not present. These mechanisms would render the security sleeve as secure as current smartcards.

According to further embodiments, coatings are added to the secure paper that would show attempts at other attacks. Such attacks could be electrical-mechanical, chemical or electromagnetic radiation. Also a mechanism could be added that would trigger the switch described above when such an attack is detected, with the result that the content layer would be left unharmed while the security layer would be permanently opaque.

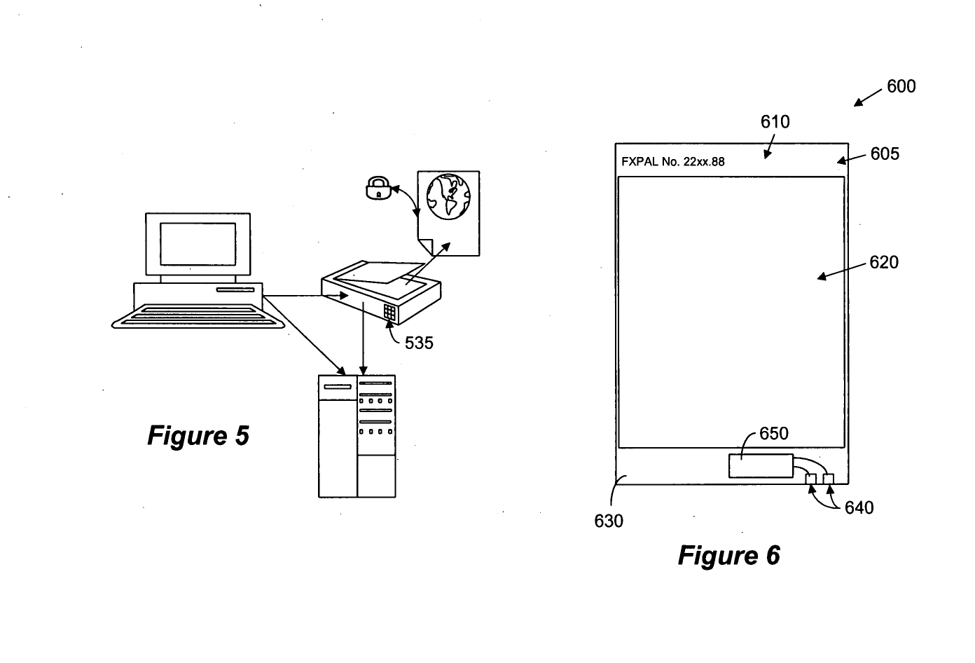

FIG. 5 depicts an example of system implementation according to an embodiment of the invention. Computer 500 is used to generate a document and send the document to an ePaper printer 510. The printer 510 energizes the ePaper and images the document onto the ePaper, so as to generate printed ePaper 520. Additionally, the security feature is enabled, so that the ePaper appears opaque unless a key 530 is used to access the ePaper. The data relating to the ePaper serial number and the key ID are stored in a central security server 540. If the key 530 is assigned to a specific user, the user's identity may also be stored in the server 540.

According to another aspect of the invention, the ePaper printer 510 also serves as the security key 530. That is, when a secured ePaper or a security sleeve is inserted into the ePaper printer 510, the user may enter a code, such as via computer 500 or optional keypad 535 provided on the ePaper printer 510. The computer 500 or ePaper printer 510 would apply the code to the security sleeve. Coding circuitry in the security sleeve would then determine whether the entered code is correct and, if so, enable application of voltage to the security layer to turn it to the transparent state.

FIG. 6 depicts a document security sleeve 600 according to an embodiment of the invention. The sleeve can be made as a flat sheet-like substrate in various sizes to fit different sizes of papers, e.g., letter size, legal size, A4, etc. The security sleeve 600 has a frame 605 and a viewing window 620 that enables viewing a document contained inside the sleeve when the security layer is in the transparent state. Initially the security sleeve would have an opening or a slit so that a document can be inserted therein. Then the opening can be sealed. In the embodiment illustrated in FIG. 6, the frame 605 includes a printed area 610 that may include pre-printed material, e.g., logo of the company, department, etc. and may include area for hand written entries, such as author, person sealing the document, date, etc. The bottom area 630 of the frame 605 includes contact pads 640 that enable application of electrical signals and power to the circuitry 650. Circuitry 650 may function to provide one or a combination of the following features: prevent application of power to the security layer unless it receives the correct security code via the pads 640; enable application of power to areas of the security layer that is approved for assuming the transparent state (when the document is only partially obscured); store metadata of the document, such as serial number, security level, etc.; record metadata relating to access, e.g., access time, access key ID, etc. As can be understood, the same general construction is also applicable for when the device is a secured ePaper, except that no opening needs to be provided to insert a paper. Instead, the ePaper may be constructed integrally with the security device or the security device may be adhered to the ePaper after the ePaper has been written to. When the ePaper is constructed integrally to the security device, the pads 640 and the circuit 650 may serve both the ePaper and the security device. The circuitry 650 may be manufactured using printed circuitry technology, such as that commercially available from PolylC GmbH & Co. KG of Germany or Philips of The Netherlands. The printed polymer thin film transistor technology enables including the security circuitry in the security sleeve without changing its flexible character. More information can be found in Innovations with Printed Electronics, by Dr. Wolfgang Clemens, PRINTO Seminar, TEKES-VTT, Helsinki, Finland, February 2005.

Thus, while only certain embodiments of the invention have been specifically described herein, it will be apparent that numerous modifications may be made thereto without departing from the spirit and scope of the invention. Further, certain terms have been used interchangeably merely to enhance the readability of the specification and claims. It should be noted that this is not intended to lessen the generality of the terms used and they should not be construed to restrict the scope of the claims to the embodiments described therein.

1. An apparatus for securing documents, comprising:
a layered arrangement of a security layer sandwiched between two electrode layers, at least one of which being transparent, said security layer assuming either an opaque state or a transparent state according to potential applied across the electrode layers, the arrangement being permanently fastened to a printed document and obscuring printed matter of the printed document when the security layer assumes the opaque state;
a coding circuitry permitting application of potential across the electrodes only when proper code has been received by the apparatus.

2. The apparatus of claim 1, further comprising a back layer forming a sleeve with the layered arrangement to enable insertion of the printed document there-between.

3. The apparatus of claim 2, wherein the layered arrangement is physically sealed to the back layer to prevent removal of the printed document without physical tempering.

4. The apparatus of claim 1, wherein upon application of the proper code, the security circuitry permits application of potential across the electrodes only about predefined regions to thereby cause the security layer to assume the transparent state only about the predefined regions.

5. The apparatus of claim 1, further comprising an ePaper layer, said ePaper layer capable of recording an image projected there-upon when connected to power supply, and maintaining the image after the removal of the power supply.

6. The apparatus of claim 5, wherein said ePaper is formed integrally to the layered arrangement.

7. The apparatus of claim 5, wherein said ePaper is affixed to the layered arrangement so as to prevent separation of the ePaper and layered arrangement without physical tempering.

8. The apparatus of claim 5, wherein said ePaper is adhered to the layered arrangement so as to prevent separation of the ePaper and layered arrangement without physical tempering.

9. The apparatus of claim 1, wherein the coding circuitry further functions to provide one or any combination of the following: enable application of power to areas of the security layer that are pre-approved for assuming the transparent state; store document metadata of the document; and store access information.

10. The apparatus of claim 9, wherein the metadata includes one or combination of:
document serial number, document security level, and creation date.

11. The apparatus of claim 9, wherein the access information comprises one or combination of: access time and access key ID.

12. A system for securing printed documents, comprising:
a security ePaper comprising a security film and an ePaper film, said security film assuming either an opaque state or a transparent state according to potential applied across electrodes of the security film, and a coding circuitry permitting application of the potential across the electrodes only when proper code has been entered; said ePaper film fabricated to record an image projected there-upon when connected to power supply, and maintaining the image after the removal of the power supply;
an image printer, said image printer constructed to apply voltage to said ePaper for printing an image onto the ePaper;
a code key having the proper code stored therein and constructed to apply the proper code to the security film so as to cause the security film to assume the transparent state.

13. The system of claim 12, further comprising a server having stored therein serial numbers and corresponding codes of security ePapers.

14. The system of claim 13, wherein said server further stores access times and access key ID's relating to each access of any of the security ePapers.

15. A method for securing printed matter, comprising:
physically sealing the printed matter onto a security film, said security film assuming either an opaque state or a transparent state according to potential applied across electrodes of the security film;
causing said security film to assume the opaque state so as to obscure at least part of the printed matter;
monitoring security key input to the security film and applying potential across the electrodes only when the security key matches a pre-assigned code.

16. The method of claim 15, further comprising recording access information whenever a security key has been input.

17. The method of claim 16, wherein the access information comprises at least an access time and an access key.

18. A thin film apparatus, comprising:
a flat sheet-like substrate having a window section and a frame section, said window section comprising a film arrangement of a security layer sandwiched between two electrode layers, at least one of which being transparent, said security layer assuming either an opaque state or a transparent state according to potential applied across the electrode layers;
contact pads applied onto the frame section;
a coding circuitry provided in the frame section and coupled to the contact pads, the coding circuitry permitting application of potential across the electrodes only when proper code has been entered via the contact pads.

19. The thin film apparatus of claim 18, further comprising means for physically sealing a document within said sheet-like substrate so that said document can be viewed only when said security layer assumes the transparent state.

20. The thin film apparatus of claim 18, wherein said substrate further comprises an ePaper layer, said ePaper layer capable of recording an image projected there-upon when connected to power supply, and maintaining the image after the removal of the power supply.

21. The thin film apparatus of claim 18, wherein said coding circuitry comprises printed polymer electronic circuit.

22. An apparatus for securing documents, comprising:
a layered arrangement of a security layer sandwiched between two electrode layers, at least one of which being transparent, said security layer assuming either an opaque state or a transparent state according to a combination of potential applied across the electrode layers and a switching signal, the arrangement being permanently fastened to a printed document and obscuring printed matter of the printed document when the security layer assumes the opaque state;
a coding circuitry permitting application of at least one of the potential or switching signal only when proper code has been received by the apparatus.

23. The apparatus of claim 22, wherein said switching signal is an electrical signal.

24. The apparatus of claim 22, wherein said switching signal is an optical signal.

25. The apparatus of claim 22, wherein said switching signal comprises illumination of said security layer.

26. The apparatus of claim 22, wherein said switching signal comprises lack of illumination of said security layer.

27. The apparatus of claim 22, further comprising a back layer forming a sleeve with the layered arrangement to enable insertion of the printed document there-between.

28. The apparatus of claim 27, wherein the layered arrangement is physically sealed to the back layer to prevent removal of the printed document without physical tempering.

29. The apparatus of claim 22, wherein upon application of the proper code, the security circuitry permits application of potential across the electrodes only about predefined regions to thereby cause the security layer to assume the transparent state only about the predefined regions.

30. The apparatus of claim 22, further comprising an ePaper layer, said ePaper layer capable of recording an image projected there-upon when connected to power supply, and maintaining the image after the removal of the power supply.

31. The apparatus of claim 30, wherein said ePaper is formed integrally to the layered arrangement.

32. The apparatus of claim 30, wherein said ePaper is affixed to the layered arrangement so as to prevent separation of the ePaper and layered arrangement without physical tempering.

33. The apparatus of claim 22, wherein the coding circuitry further functions to provide one or any combination of the following: enable application of power to areas of the security layer that are pre-approved for assuming the transparent state; store document metadata of the document; and store access information.

34. The apparatus of claim 33, wherein the metadata includes one or combination of: document serial number, document security level, and creation date.

35. The apparatus of claim 33, wherein the access information comprises one or combination of: access time and access key ID.
